(19) United States
(12) Patent Application Publication
(10) Pub. No.: US 2017/0329861 A1
(43) Pub. Date: Nov. 16, 2017

(54) METHOD AND SYSTEM FOR FACILITATING OPERATIONS BASED ON DATA

(71) Applicant: Sanjaykumar BHATIA, Katy, TX (US)

(72) Inventor: Sanjaykumar BHATIA, Katy, TX (US)

(21) Appl. No.: 15/155,992

(22) Filed: May 16, 2016

(51) Int. Cl. G06F 17/30

(52) U.S. Cl. CPC G06F 17/30893; G06F 17/30569; G06F 17/30294; G06F 17/303

(57) ABSTRACT

The method and system for facilitating operations based on data include a control system associated with a legacy database and then a master database. The control system generates a control signal for a particular activity, such as a real estate management system generating reminders completing a sale. The legacy database includes a legacy data profile, having legacy data fields, and legacy data. The master database includes a master data profile, having master data fields. A conversion menu associates master data fields with legacy data fields so as to form a conversion data field and a data template. Legacy data is transferred corresponding to the conversion data fields and forms converted legacy data in the master database. The control system now operates by the converted legacy data, so that the control signal is based on the master database. The system and method can be add-on software to the legal system.

### CROSS-REFERENCE TO RELATED APPLICATIONS

See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to business operations based on data collected in a database. In particular, the present invention relates to real estate management activity based on property information. Even more particularly, the present invention relates to transferring data, such as property information, from a legacy management system to a master management system so that the real estate activity is controlled by the master management system.

### 2. Description of Related Art Including Information Disclosed Under 37 CFR 1.97 and 37 CFR 1.98

During implementation for real estate asset and portfolio handling, data migration covers the transfer of collected data and information in the current system to a new system. The success of the new system depends on how effectively and accurately data and information have been migrated to the new system.

There are known systems and methods for data migration.

Legacy Migration System Workbench (LMSW) is a generic tool used for data migration of kinds of data, including financials, materials management, plant maintenance and logistics. The method of LMSW requires specialized skilled technical resources to generate a computer program or tool. The method comprises: recording of a flow of screens or specialized function modules in the background to execute the data migration in a certain pattern; setting data is a spreadsheet; converting the spreadsheet into a delimited text file; and migrating the data according to the pattern. LMSW relies on the step of migrating by iterations of instructions. The user is able to see the results of data iterations. The tool provides warning or error messages for each potential problem, and the problems must be resolved before the migration to be considered final and completed.

There are problems with LSMW. The LSMW tool is complex to develop and use because the user is required to execute many iterations and sequence of programs before the data can be actually migrated. The formatting of data is also very complex as the data columns need to be in a certain sequence, and error messages are generated for each change to the sequence, including even slight changes. The error messages can be difficult to understand, so that the response to cure the error is also difficult to ascertain. The LSMW tool is not user friendly because of the complexity. The iteration and sequence demand compliance by the user without any flexibility. The formatting of data also requires strict adherence so that any unexpected, such as a null value or missing information, can disrupt the method of the LSMW tool. There is constant monitoring and correction as the number of error messages increase. Furthermore, the LSMW tool requires advanced knowledge. As another consequence of the complexity, a developer must have advanced knowledge and skill to create the LSMW tool, and the users must also demonstrate a degree of proficiency in order to implement and respond to the error messages generated by the LSMW method.

Another known data migration method includes custom programs, which are developed for the particular collections of data and information. For example, real estate information may cover buildings, land, campuses, offices, residences, warehouses, and other structures. The data collected for a campus for s school can differ significantly from data collected for an industrial warehouse. Migration of the data from a system for a campus to a system for an industrial warehouse or a system for both the campus and the warehouse requires a custom program or tool to account for the particularities of each data set.

The cost disadvantage is clear. The custom tool requires developers with special skill sets and programming language experts to develop customized in house programs to migrate the data from one system to another system. Custom tools require a large development effort, encompassing thousands of lines of code, offshore contractors in different countries, cross functional teams for writing, approving, developing, and deploying specifications, extensive testing, and documentation for future reference. There are also upgrades, affecting active development of the custom tool. A custom tool requires inputs from functional, technical and infrastructure teams consisting of high skilled technical resources. These resources need to know the high level programming language and make complex designs. In some large projects, special cross skilled data conversion teams are formed consisting of resources with functional, technical, spreadsheets, infrastructure and business subject matter experts. The teams are spread all over the world for efficiency and around the clock work days.

Additionally, the method of the custom tool is not flexible. Since a custom tool is made to custom specifications by business and functional teams, the custom tool only works for a particular set of data, fields, and mapping. For example, a real estate lease contract is a negotiable lease between two parties, and the terms and conditions can vary greatly based on conditions, geography and applicability. There could be thousands of negotiated leases with widely different terms and conditions. A custom tool is built to address all such terms and conditions. However, even after the lease negotiations are complete and signed off, the terms may change to new conditions that were not part of the custom tool. Changes cannot be entered at the speed of business because the testing and reliability cannot be replicated with the speed of change of terms and conditions. Even minor changes cannot be accommodated in the method of the custom tool.

The custom tool also has the disadvantage of maintenance. Since dynamic changes cannot be entered, these changes require incorporation into the custom tool as maintenance of the custom tool. If a dynamic change persists, then the custom tool requires updates to account for the new need. As the systems update, the method for migrating data must also be updated to remain compatible with the updated system.

Still another data migration method includes a third party tool. In contrast to the LMSW tool and custom tool for a particular legacy system, a third party tool involves a method to convert any legacy system to any master system. A third party tool is outside of the both the legacy system and the master system, so a license and fees for the third party tool are required. In complex data migration, several different parties may be required to have the same third party tool and the corresponding licenses, including the same version of the third party tool. In many cases, the third party tool relies on the third party to address problems and modifications. The user is no longer in control of the process, and the continued availability of the third party is not assured. Additionally, the third party tool requires additional training outside of the legacy system and the master system. The ability to use the third party tool changes as teams on both sides of the legacy system and master system change. The training time and interchangeability of the team can delay complex projects.

Additionally, various references are available in the field. The baseline disclosures of data migration begin with transferring data to storage for use at a later time. The data migration relates to data with the same fields and categories.

U.S. Pat. No. 8,019,965, issued to Agombar, et al., on 13 Sep. 2011, describes a data migration method. The invention relates to data storage capacity and migrating overflow data between local memory and remote memory storage space. The master database and the parent database are already the same. The scope of the coverage relates to particular methodology of mapping and migrating in a sequence from the parent database into storage.

U.S. Patent Publication No. 20090125589, published for Anand et al. on 14 May 2009, relates to a master data profile related to collaboration session data. The master data profile includes the information collected from the collaboration, including participant information. The data migrates from one host to another host. The application was successfully granted as U.S. Pat. No. 8,386,609, and the coverage relates to specific collaboration systems and methodology for handling dropped users from a collaboration session.

Migration of user settings is known to be an established use of data migration. Instead of data itself, the detail about the user migrates between systems.

U.S. Patent Publication No. 20020111972, published for Lynch et al. on 15 Aug. 2002, discloses data migration for installed software with user settings. The local user settings migrate to a server, and then migrate to a remote station. The same user settings are accessible at the remote station.

U.S. Patent Publication No. 20140229592, published for Baribault et al. on 14 Aug. 2014, also discloses data migration of users settings between phones. Personal phone settings can be stored and returned to a second phone.

U.S. Pat. No. 8,744,423, issued on 3 Jun. 2014 to Baribault et al., was successfully patented as a continuation of the '592 publication by Baribault et al. The allowed version of the data migration invention covers specifics of the first phone availability and the second phone activity. Furthermore, only mobile device personalization migrated as the data between phones. There was no generalization for other data migration.

The recent successfully granted patents are subject matter specific (collaboration sessions and mobile phone settings). In those systems, the data has commonalities between the legacy system and the master system. For example, a user name in one phone is directly analogous to the user name in another phone. The connection is easy because of the limited scope of the data being migrated. In a collaboration session, all users have already agreed to work on the same platform and same fields. There is no actual conversion.

In the field of real estate information, the range of real estate data does not fit such clearly analogous fields between the legacy system and the master system. For example, lease terms for rented property may not be directly analogous to a legacy system for only single family residences. For data migration in a real estate context known, the real estate data has only migrated from the master database of real estate information to a remote database for selected parameters, such as listings in a particular zip code.

Two patent applications by Fackrell et al are U.S. Patent Publication No. 20150006254 published on 1 Jan. 2015 and U.S. Patent Publication No. 20150220944 published on 6 Aug. 2015 disclose data migration in a real estate information context from a master data schema to new local schema. The main embodiment is local data being filtered from a master listing. The diverse real estate data is being reduced to migrate to a local drive, such as filtering all homes less than $100K. The fields are not changing as the systems migrate data.

Otherwise, real estate data migration has continued in the established migration of only user settings, not actual real estate data. U.S. Patent Publication No. 20150293760, published for Alevoor et al. on 15 Oct. 2015, addresses the different parent database and master database concept. In this application, data migration is disclosed for more complex systems. The data to be migrated includes the user settings for applications. The system collects the user settings from installed software into a cloud database. The user settings are stored on the cloud for migration to each application. Data as user settings can be migrated to different applications, so the data is migrating from one application to another application via a master database in the real estate context without the actual real estate data.

It is an object of the present invention to provide a method for facilitating operations based on data, in particular operations of a control system.

It is another object of the present invention to provide a method for facilitating operations of a control system based on a master database of data from a legacy database of the same data.

It is another object of the present invention to provide a method for facilitating operations of a control system based on migrated data from a legacy database to a master database.

It is an object of the present invention to provide a control system for facilitating operations based on data from a master database of data, wherein the data originated from a legacy database.

It is another object of the present invention to provide a control system based on migrated data from a legacy database to a master database.

It is another object of the present invention to provide a management system to control real estate activity and transactions based on data migrated from a legacy database to a master database.

It is an object of the present invention to provide a computer program product to facilitate operations based on the data from a master database, when the data originated from a legacy database.

It is another object of the present invention to provide a computer program product to migrate data from a legacy database to a master database.

It is another object of the present invention to provide a computer program product as an add-on to a control system for real estate activity and transactions based on data migrated from a legacy database to a master database.

These and other objectives and advantages of the present invention will become apparent from a reading of the attached specification.

### BRIEF SUMMARY OF THE INVENTION

Embodiments of the method and system for facilitating operations based on data include a control system. The control system generates a control signal corresponding to a parameter. In one embodiment, the control system is a real estate management system, and the parameters are real estate decisions, such as deciding to sell, moving a timeline for construction, confirming occupancy, increasing rent, and generating an alert of a deadline. Other parameters are also possible. The control signal can be manual, decided each time by the user, or automated. Complex data drives each control signal for the respective parameter. With complex parameters, complex data is required.

The present invention facilitates operations because the complex data can now be moved without the limitations of the prior art for real estate data. Operations of the control system have less delay and disruption than prior art moves or migrations of the complex data. By migrating data from a legacy or original database of the control system into a master or new database of the control system with the present invention, the control signals still control parameters based on data, and the control system can continue to function. In one embodiment, the control system is a real estate management system, and the real estate management system can convert from one legacy database to another master database, when the advantages and functionality of the other master database is desired. Upgrades from the legal database to a master database no longer have the disadvantages of the prior art.

In the embodiment of the method, a control system associated with a legacy database is assembled. The legacy database is comprised of a legacy data profile, having legacy data fields, and legacy data, and the control signal is determined by the legacy data and controls a parameter of the control system. A master database is comprised of a master data profile, having master data fields, is provided, wherein the master database is an upgrade from the legacy database with different functionality for generating different control signals for the parameters and accounting for different parameters not possible with the legacy database. The method further includes providing a conversion menu comprised of at least one of the master data fields of the master data profile, and associating the at least one of the master data fields with at least one of the legacy data fields so as to form at least one conversion data field. A data template is generated based on the at least one conversion data field. Then legacy data corresponding to the data template is transferred according to the at least one conversion data field so as to form a filled data template. The method further includes incorporating the legacy data of the filled data template into the master database from the filled data template so as to form converted legacy data. The master database is now comprised of the master data profile and the converted legacy data, such that the control signals are now master control signals to control the corresponding parameters. The complex data has been converted into a format for utilization in the master database, so that there are fewer delays and difficulties in the migration from the legacy database to the master database. A parameter or new parameter based on the new master database can now be controlled by the control system. In the embodiment of the real estate management system, the decisions for a real estate transaction can now be decided based on additional data not available in the legal database.

Embodiments of the present invention include the system and computer program product for performing the steps of facilitating operations. The system includes the processor and memory storage compatible with the legacy database and master database. The computer program product incorporates the present invention in an add-on software format for compatibility with the control system with legacy data. The data migration of complex data in the legacy database to the master database facilitates the operation of the control system, so that the control system can upgrade and improve to the master database. The present invention overcomes the prior art difficulties of converting complex data.

### BRIEF DESCRIPTION OF THE SEVERAL VIEWS OF THE DRAWINGS

FIG. 1 is a schematic view of an embodiment of the control system of the present invention as a real estate management system.

FIG. 2 is flow diagram of the embodiment of the method, system and computer program product for facilitating operations.

### DETAILED DESCRIPTION OF THE INVENTION

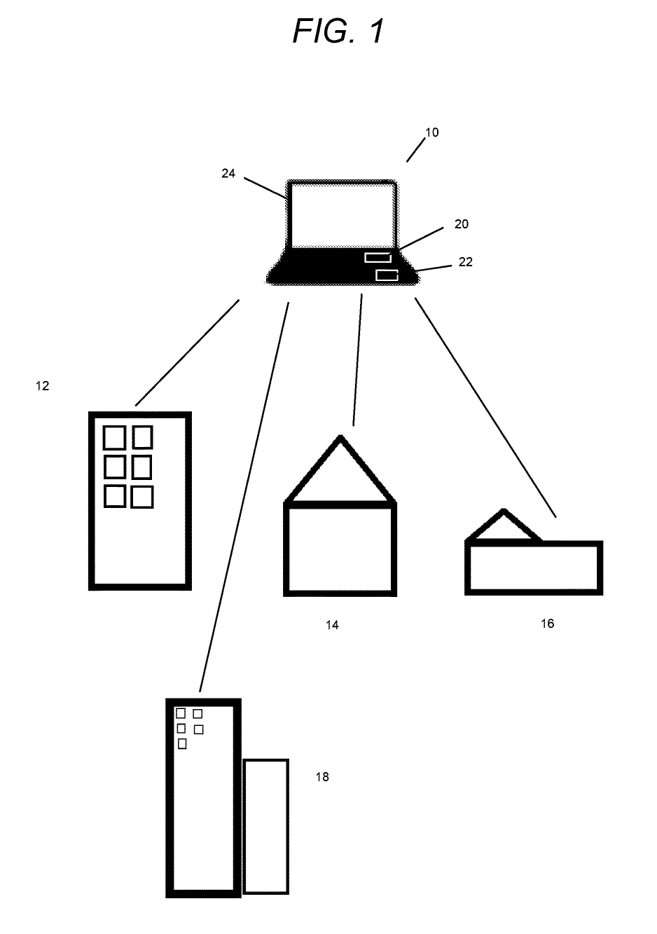

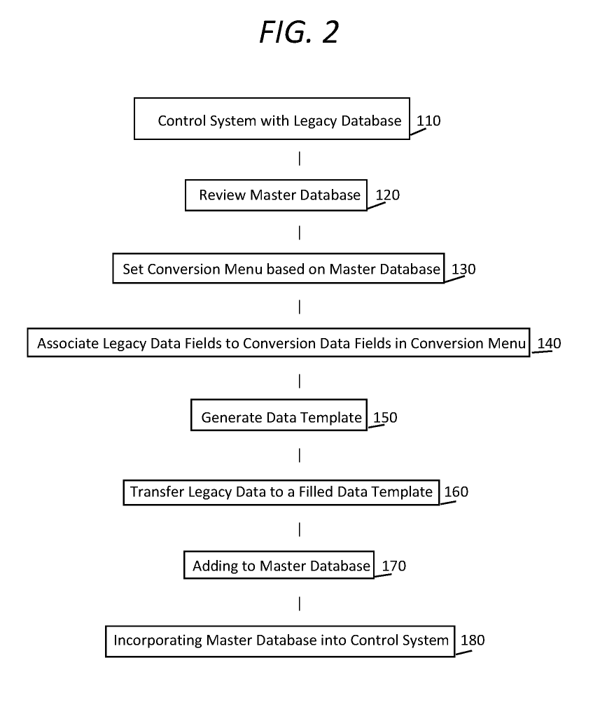

Referring to FIGS. 1 and 2, the method and system of the present invention facilitate operations based on data. The system is a control system for a particular activity, and decisions, related to performance of the activity and selection of activities, are both determined by data. Embodiments of the present invention are specifically related to real estate data and real estate activities. FIG. 1 shows the system 10 for managing properties, such as apartments 12, homes 14, mixed used structures 16, and high rise buildings 18. The control system 10 of FIG. 1 generates a control signal corresponding to a parameter. When the control system 10 is a real estate management system, the parameters are activities related to real estate decisions. Real estate data is a particular concern because the data is so complex. There is no easy matching between data sets, as in the prior art references for migrating user settings. The relatedness and uniformity of username, password, and users alerts are relatively simple and do not require much understanding of the old phone system transferring to a new phone system.

There are complexities to real estate data unlike other data sets migrating between systems. A real estate management system can be set for monitoring apartment units. When that data migrates to another real estate management system, the particular data for lease term, monthly rental rate, number of occupants, pet deposits, and other aspects for monitoring apartments is so specific, that it is difficult to convert such data into a usable format in the other real estate management system. The obstacles are particularly daunting, when an older real estate management system attempts to convert to a new comprehensive real estate management system. For the example, the system of monitoring apartment units may need to be merged into a global company with a comprehensive real estate management system with real estate assets spanning from residential homes, industrial warehouses, convention centers, high rise buildings, to performance venues. The present invention addresses the migration of complex data, such as real estate data, for facilitating operation of system. The present invention allows the real estate management system to more easily upgrade, despite the specificity and complexity of the data.

FIG. 2 shows a flow diagram of the method of the present invention. The method for facilitating operations based on data includes assembling a control system associated with a legacy database 110. The legacy database is comprised of a legacy data profile and legacy data, and the legacy data profile is comprised of legacy data fields. The legacy data fields are the organization of the legacy data. In one embodiment, the legacy database is the database of the old real estate management system. In the method of the present invention, the control system generates the control signal determined by the legacy data. The parameters of the control system are determined by the control signal. For example, “name of renter” is a legacy data field, and the names of renters are the legacy data. A parameter of sending notices to renters is determined by the names of renters.

The next step is providing a master database for review 120. Analogous to the legacy database, the master database is comprised of a master data profile, and the master data profile is comprised of master data fields. There is no “master data” yet because the legacy data is going to be converted into “master data”. Then, the method provides a conversion menu comprised of at least one of the master data fields of the master data profile in step 130. The user can select the master data fields or other programmers may select the master data fields. The relatedness to the legacy data fields is considered for matching. In the example of the names of renters, the master data field may be “tenant names”. A user, a panel of developers, or an automation by key words may be used to provide the conversion menu of conversion data fields.

FIG. 2 shows associating the master data fields and the legacy data fields with respective conversion data fields 140 and generating the data template 150. The legacy data is being converted in the migration from the legacy database. The user or the panel of developers can be used to make the associations to link legacy data fields to master data fields through the conversion data fields. With at least one conversion data field, a data template can be completed. The intermediate conversion of the present invention allows for correction and modification before implementing into the master database. The testing and verification can be performed before any manipulation of the master database or before the control system is generating control signals based on possibly bad or incomplete data. The data template becomes a conversion filter for the translation of legacy data into an organization compatible with the master database.

The legacy data is now transferred 160 to form a filled data template. At least one conversion data field into the data template identifies the legacy data of the associated legacy data field. In some embodiments, the filled data template is a spreadsheet or even a column in a spreadsheet corresponding to the legacy data to be migrated. Again, filling at this step enables error correction and modification of the data template before interaction with the master database and control system. Activities of the control system are not jeopardized.

The method further includes incorporating the legacy data of the filled data template into the master database from the at least one conversion data field. The legacy data from the data template forms converted legacy data, which is now compatible with the master database. The master database is now completed with the master data profile and converted legacy data. For example, the “tenant names” field of the master data profile is now filled with the names from the legacy database.

FIG. 2 shows the step of associating the control system with the master database 180. The converted legacy data enables the master database to engage the control system for operations. The control signal is now a master control signal based on converted legacy data and the master database instead of the legacy data and the legacy database. The control of the parameter is based on the master database through the master control signal. The upgrade of the master database allows operations with less disruption to actual activities. The migration of the complex data allows the master control signal, based on the master database, to affect the activity of the control system. An old real estate management system can be upgraded to new logic of a comprehensive real estate management system without losing the legacy data collected in the past and without regenerating the legacy data manually.

In one embodiment, FIG. 2 shows adding to the master database 170. In this variation, the master database is comprised of the master data profile, additional master data, and the converted legacy data. When the master database is more comprehensive, the master database may require more data than collected from the legacy database. For example, citizenship of the tenant, may not have been collected by an old real estate management system, but citizenship is a master data field for real estate assets managed by a global company. The present method accounts for this adjustment in the upgrade over the old real estate management system. The complex data can increase in complexity, depending upon the master database. Before generating master control signals on possibly incomplete or null values in master data fields, the present invention allows the entry of the additional master data before incorporation into the control system. The errors and repairs to the control system are reduced.

In the present invention, the legacy data profile is different from the master data profile. The legacy data profile is comprised of legacy data fields that are different from the master data fields. In prior art systems, the fields were the same in user settings. The ringtones and alerts were the same ringtones and alerts. In complex data, the associations are not identified in the same way. A user or panel of developers can make the selections to account for any old real estate management system.

In some embodiments, the data template is installed in the control system. The integration of the template can maintain a master database with continued access to the legacy database. The control system can have an add-on with easy access to the method of the present invention. Furthermore, the method includes the steps of selecting the control signal based on the legacy data so as to generate the control signal, and selecting the master control signal based on the converted legacy data so as to generate the master control signal, after the step of incorporating the legacy data. The control system is manual or automated. The user can actively select the parameters, making the real estate decision based on the newly processed master data and converted legacy data. For example, the user can decide on the activity to sell a property based on the legacy data, or the control system can automatically decide on the activity to sell a property based on preset conditions, such as a bottom price, of the legacy data. After the migration, the user can still decide on the activity to sell a property based on the master data and converted legacy data, or the control system can automatically decide on the activity to sell a property based on preset conditions of the master data and the converted legacy data.

FIG. 1 illustrates the embodiment of the present invention as a system for performing operations based on data. The system 10 is still the control system, such as a real estate management system. FIG. 1 shows the computer 24 having a processor 20, and a memory storage 22 associated with the processor. As a system 10, the invention is computer-based with the processor performing the actions for the eventual physical operations. The memory storage 22 maintains the legacy database, legacy data, the master database, converted legacy data, and the master data. The processor 20 makes the conversion menu, data template, and filled data template. Additionally, the processor 20 generates the control signal for the parameter, which is the actual command based on data. In the embodiment of the real estate management system, the control signal can be the command to send a reminder for a late rental payment to a tenant. The system 10 allows for an upgrade so that the legacy data can transition to newer programs. The decisions do not have to be automated. The user can select the master data signal in the same manner as the data signal. The manual control of the decisions remains driven by the legacy data, master data, and converted legacy data.

Still another embodiment of the present invention is the computer program product. The invention can be a computer usable medium having a computer readable program. As an “add-on”, the present invention can be available in coordination with existing software. A button on a spreadsheet program is compatible with being the computer program product of the present invention. The computer readable program is executed on a computer of a control system. As an add-on, the invention is part of the control system. The computer executing a property sale and migrating legacy data into a new program is the same. The process steps of the invention as carried out by the computer program product are the same as the process steps without a computer.

Another embodiment of the present invention includes real estate information as the legacy data, master data, and converted legacy data. For example, real estate information includes the data maintained by the enterprise such as business data, property management company details, corporate data, individual data, campus, buildings, lands, floors, conference rooms, apartments, shops, retail malls, commercial and industrial warehouses, logistics warehouses, lobbies and cafeterias etc. The real estate data may be stored in heterogeneous sources, such as emails and databases/spreadsheets. The real estate data may be structured in a spreadsheet or free form in a word processing document.

In this embodiment, the legacy database starts as a source database, and the conversion is to a master database or target Enterprise Resource and Planning system database or target ERP. The mapping is the complex linking of the fields in source database to the target ERP. The present invention determines which legacy data field in the source database is represented by what master data field in target ERP. For example, a legacy data field is called “Lease Start Date”, while the target ERP has a master data field called “Contract start Date”. The present invention recites the steps of the conversion menu and data template to accomplish mapping, which is the starting point for the developers. These steps require resources, which have a good understanding of all the aspects of data migration namely. Business users with understanding of the importance and business relevance of each field, and technical resources with knowledge of the data fields of both the source database and the target ERP database, and technical experts with understanding of the target ERP database with regard to how legacy data can be best utilized in the new target ERP database. The steps related to mapping are a joint exercise between all these people and each resource input based on their respective skill set is very critical.

The step of assembling the control system and providing the master database includes selecting the legacy data to be migrated. For example, in the real estate management system, a user may select legacy data related to a building or land or parking area etc. The selection is a trigger point for the user to start the data migration from the source system to the target ERP database.

The conversion menu can be a business application programming interface (BAPI). The method identifies the BAPI for the master data fields of the master database. The BAPI is used to start the data migration from the source database to the target ERP database.

Next, the data template is formed from the data fields of the BAPI, including legacy data and enhanced or added custom fields to be completed. In some embodiments, once the BAPI is identified, all fields are can be extracted, such as all fields related to “parking area”. The conversion data fields link associated data fields between the source system and the target ERP database. The enhanced and custom data fields are also compiled to be filled. The method can further include entering relevant descriptions and details, so that the data template as a spreadsheet to be filled has instructions and descriptions.

The step of transferring and associating legacy data can be performed with another BAPI tool. The data template may require more than legacy data in order to be filled. The conversion data fields that can be filled or migrated are selected with the other BAPI tool to select those legacy data fields for download into the spreadsheet. There can be a separate “get List” for this transfer and association of legacy data. The conversion data fields are limited to legacy data fields, so a user cannot select a wrong data field for the migration.

The data template is filled, just as entering data into a spreadsheet. Some legacy data is migrated, and some additional master data must be entered. The filled data template can be an excel file uploaded with all fields mapped.

In some embodiments, there is a step of simulating the master database. The filled data template can be tested for errors before committing the legacy data and additional master data into the target ERP database. Errors and problems can be resolved before affecting the target ERP database.

Finally, the legacy data and additional master data are committed to the target ERP. After any necessary simulations and resolution of any mapping errors, the aim is to check if the data is compatible and is not violating any program logic or system checks or validations. Once approved and correct, the master database is associated with the legacy data and additional master data. The legacy data has become converted legacy data for use in target ERP database. The control system can now use target ERP programs with a completed target ERP database. The control system now regulates operations based on the data in the target ERP database with less disruption and costs.

The present invention provides a method for facilitating operations based on data, in particular real estate management on a computer. The complex data in the real estate industry cannot be accommodated by the prior art data migration. The costs, time and adjustments of the prior art are prohibitive for many users with legacy systems, when upgrading to a more comprehensive system. The method of the present invention provides a select migration based on the legacy database and the master database of the upgrade for the data used in common between both databases. The legacy data can migrate, and the master database will be able to control the real estate properties when the legacy data becomes converted legacy data compatible with the master database. The master database can also include entered master data for enhanced or custom data fields for the upgraded control system. Upgrading the software of the real estate management system may require additional information that was not maintained in the old legacy database. The present invention provides the flexibility to use as much old legacy data as selected and to enter new data, which was not previously compiled or stored in the legacy database. For the complex data, the present invention is the method, system, and computer program product to migrate data from a legacy database to a master database. In some embodiments, the computer program product is an add-on to a control system switching from software using the legacy database to new software using a master database. When the control system is a real estate management system, the activity and transactions for real estate are facilitated by the present invention to migrate data from the legacy database to the master database.

The foregoing disclosure and description of the invention is illustrative and explanatory thereof. Various changes in the details of the illustrated structures, construction and method can be made without departing from the true spirit of the invention.

I claim:

1. A method for facilitating operations based on data, said method comprising the steps of:
assembling a control system associated with a legacy database, said control system generating a control signal, said legacy database being comprised of a legacy data profile and legacy data, said control signal being determined by said legacy data, said legacy data profile being comprised of legacy data fields;
controlling a parameter of said control system according to said control signal;
providing a master database being comprised of a master data profile, said master data profile being comprised of master data fields;
providing a conversion menu comprised of at least one of said master data fields of said master data profile;
associating said at least one of said master data fields with at least one of said legacy data fields so as to form at least one conversion data field;
generating a data template based on said at least one conversion data field;
transferring legacy data corresponding to said at least one conversion data field into said data template so as to form a filled data template;
incorporating said legacy data of said filled data template into said master database from said at least one conversion data field, said legacy data being associated with said at least one master data field according to said data template so as to form converted legacy data, said master database being comprised of said master data profile and said converted legacy data;
associating said control system with said master database, said control system generating a master control signal, said master control signal being determined by said converted legacy data in said master database; and
controlling said parameter of said control system according to said master control signal.

2. The method for facilitating operations, according to claim 1, wherein said legacy data profile is different from said master data profile.

3. The method for facilitating operations, according to claim 2, wherein legacy data fields are different from master data fields.

4. The method for facilitating operations, according to claim 1, further comprising the step of:
providing additional master data for said master database, said master database being comprised of said master data profile, additional master data, and said converted legacy data.

5. The method for facilitating operations, according to claim 1, further comprising the step of:
installing said data template in said control system.

6. The method for facilitating operations, according to claim 1, wherein said control system is comprised of a real estate management system, wherein said legacy data is comprised of real estate information, and wherein said parameter is a real estate decision.

7. The method for facilitating operations, according to claim 1, further comprising the steps of:
selecting said control signal based on said legacy data so as to generate said control signal; and
selecting said master control signal based on said converted legacy data so as to generate said master control signal, after the step of incorporating said legacy data.

8. A system for performing operations based on data, said system comprising:
a processor; and
a memory storage associated with said processor,
wherein said processor performs actions of:
maintaining a legacy database in said memory storage, said legacy database being comprised of a legacy data profile and legacy data, said legacy data profile being comprised of legacy data fields;
generating a control signal determined by said legacy data;
controlling a parameter according to said control signal;
installing a master database being comprised of a master data profile, said master data profile being comprised of master data fields;
providing a conversion menu comprised of at least one of said master data fields of said master data profile;
associating said at least one of said master data fields with at least one of said legacy data fields so as to form at least one conversion data field;
generating a data template based on said at least one conversion data field;
transferring legacy data corresponding to said at least one conversion data field into said data template so as to form a filled data template;
incorporating said legacy data of said filled data template into said master database from said at least one conversion data field, said legacy data being associated with said at least one master data field according to said data template so as to form converted legacy data, said master database being comprised of said master data profile and said converted legacy data;
generating a master control signal determined by said converted legacy data in said master database; and
controlling said parameter according to said master control signal.

9. The system for facilitating operations, according to claim 8, wherein said legacy data profile is different from said master data profile.

10. The system for facilitating operations, according to claim 9, wherein legacy data fields are different from master data fields.

11. The system for facilitating operations, according to claim 8, wherein said processor further performs actions of:
providing additional master data for said master database, said master database being comprised of said master data profile, additional master data, and said converted legacy data.

12. The system for facilitating operations, according to claim 8, wherein said parameter is a real estate decision, and wherein said legacy data is comprised of real estate information.

13. The system for facilitating operations, according to claim 8, wherein said processor further performs actions of:
selecting said control signal based on said legacy data so as to generate said control signal; and
selecting said master control signal based on said converted legacy data so as to generate said master control signal, after the step of incorporating said legacy data.

14. A computer program product, comprising:
a computer usable medium having a computer readable program,
wherein said computer readable program is executed on a computer of a control system being comprised of a processor; and a memory storage associated with said processor, and
wherein said processor performs actions of:
maintaining a legacy database in said memory storage, said legacy database being comprised of a legacy data profile and legacy data, said legacy data profile being comprised of legacy data fields;
generating a control signal determined by said legacy data;
controlling a parameter according to said control signal;
installing a master database being comprised of a master data profile, said master data profile being comprised of master data fields;
providing a conversion menu comprised of at least one of said master data fields of said master data profile;
associating said at least one of said master data fields with at least one of said legacy data fields so as to form at least one conversion data field;
generating a data template based on said at least one conversion data field;
transferring legacy data corresponding to said at least one conversion data field into said data template so as to form a filled data template;
incorporating said legacy data of said filled data template into said master database from said at least one conversion data field, said legacy data being associated with said at least one master data field according to said data template so as to form converted legacy data, said master database being comprised of said master data profile and said converted legacy data;
generating a master control signal determined by said converted legacy data in said master database; and
controlling said parameter according to said master control signal.

15. The computer program product, according to claim 14, wherein said legacy data profile is different from said master data profile.

16. The computer program product, according to claim 15, wherein legacy data fields are different from master data fields.

17. The computer program product, according to claim 14, wherein said processor further performs actions of:
providing additional master data for said master database, said master database being comprised of said master data profile, additional master data, and said converted legacy data.

18. The computer program product, according to claim 14, wherein said processor further performs actions of:
installing said data template in said control system.

19. The computer program product, according to claim 14, wherein said control system is comprised of a real estate management system, wherein said legacy data is comprised of real estate information, and wherein said parameter is a real estate decision.

20. The computer program product, according to claim 14, wherein said processor further performs actions of:
selecting said control signal based on said legacy data so as to generate said control signal; and
selecting said master control signal based on said converted legacy data so as to generate said master control signal, after the step of incorporating said legacy data.
